(19) United States
(12) Patent Application Publication
(10) Pub. No.: US 2022/0140418 A1
(43) Pub. Date: May 5, 2022

(54) IN-SITU X-RAY DIFFRACTION ANALYSIS APPARATUS INCLUDING PELTIER-TYPE TEMPERATURE CONTROL UNIT AND ANALYZING METHOD USING THE SAME

(71) Applicants: SEOUL NATIONAL UNIVERSITY R&DB FOUNDATION, Seoul (KR); INSTITUTE FOR BASIC SCIENCE, Daejeon (KR); THE INDUSTRY & ACADEMIC COOPERATION IN CHUNGNAM NATIONAL UNIVERSITY (IAC), Daejeon (KR)

(72) Inventors: Yung-Eun Sung, Seoul (KR); Jungjin Park, Seoul (KR); Jae-Hyuk Park, Seoul (KR); Jong Sig Lee, Gyeonggi-do (KR); Chunjoong Kim, Daejeon (KR); Shin-Yeong Kim, Seoul (KR)

(21) Appl. No.: 17/518,327

(22) Filed: Nov. 3, 2021

(30) Foreign Application Priority Data
Nov. 4, 2020 (KR) 10-2020-0146385
Nov. 1, 2021 (KR) 10-2021-0148134

(51) Int. Cl. H01M 10/6572; G01N 23/2251; H01M 10/615; H01M 10/613; H01M 10/052

(52) U.S. Cl. CPC H01M 10/6572; G01N 23/2251; H01M 10/615; H01M 10/613; G01N 2223/66; G01N 2223/418; G01N 2223/3103; G01N 2223/3106; H01M 10/052

(57) ABSTRACT

An in-situ X-ray analysis apparatus includes: a potentiostat connected to an in-situ electrochemical cell and configured to control a voltage, current, and time of the in-situ electrochemical cell, or to record voltage, current, resistance, capacity, and time information of the in-situ electrochemical cell; an X-ray analysis apparatus configured to obtain X-ray diffraction information of the in-situ electrochemical cell; and a controller connected to the X-ray analysis apparatus and the potentiostat and configured to provide or receive a signal to or from each of the X-ray analysis apparatus and the potentiostat.

### CROSS-REFERENCE TO RELATED APPLICATION

This application is based on and claims priority under 35 U.S.C. § 119 to Korean Patent Application No. 10-2020-0146385, filed on Nov. 4, 2020, and Korean Patent Application No. 10-2021-0148134, filed on Nov. 1, 2021, in the Korean Intellectual Property Office, the disclosure of which is incorporated by reference herein in its entirety.

### BACKGROUND

### 1. Field

The inventive concept of the present disclosure relates to an in-situ X-ray diffraction analysis apparatus including a Peltier-type temperature control unit and an analyzing method using the in-situ X-ray diffraction analysis apparatus, and more particularly, to an in-situ X-ray diffraction analysis apparatus capable of an in-situ X-ray diffraction analysis in an environment controlled by a Peltier-type temperature control unit, and an analysis method using interlocking between the in-situ X-ray diffraction analysis apparatus and an electrochemical analysis apparatus.

### 2. Description of the Related Art

Recently, as demands for using lithium ion batteries in various applications such as electric vehicles, small mobile devices, and energy storage systems have increased, there is a need to optimize the performance of lithium ion batteries according to various requirements for various applications. In particular, for use in battery systems of electric vehicles, electrochemical properties of new anode active material candidates and cathode active material candidates, which satisfy various requirements such as large capacity, low manufacturing cost, fast charging possibility, and stable operation under various temperature conditions exposed to electric vehicles, have been actively studied.

However, with respect to some of the new anode active materials and cathode active materials, the relationship between the microstructure of an active material and the electrochemical performance thereof according to charging and discharging has not been clearly identified, or whether a certain microstructure change occurs according to charging and discharging under certain temperature conditions has not been clearly identified, and thus, performance improvement and commercialization of the candidate materials are difficult.

### SUMMARY

The inventive concept of the present disclosure provides an in-situ X-ray analysis apparatus for precisely analyzing the microstructure of an electrochemical cell in a variable temperature range of about −10° C. to about 80° C.

The inventive concept of the present disclosure also provides an in-situ X-ray analysis method of precisely analyzing the microstructure of a material according to voltage, current, capacity, and time during charging and discharging of an electrochemical cell in a variable temperature range of about −10° C. to about 80° C.

Additional aspects will be set forth in part in the description which follows and, in part, will be apparent from the description, or may be learned by practice of the presented embodiments of the disclosure.

According to an aspect of the inventive concept of the present disclosure, there is provided an in-situ X-ray analysis apparatus including: a potentiostat connected to an in-situ electrochemical cell and configured to control a voltage, current, and time of the in-situ electrochemical cell, or to record voltage, current, resistance, capacity, and time information of the in-situ electrochemical cell; an X-ray analysis apparatus configured to obtain X-ray diffraction information of the in-situ electrochemical cell; a Peltier-type temperature control unit including a base plate on which the in-situ electrochemical cell is mounted, a cap portion covering the in-situ electrochemical cell and having a pair of openings through which X-rays pass through the in-situ electrochemical cell, a temperature controller for heating or cooling the base plate, and a fluid supply line for supplying cooling water to a lower portion of the base plate; and a controller connected to the potentiostat, the X-ray analysis apparatus, and the Peltier-type temperature control unit and configured to provide or receive a signal to or from each of the potentiostat, the X-ray analysis apparatus, and the Peltier-type temperature control unit.

The temperature controller may include a Peltier-type thermoelectric element, wherein the Peltier-type temperature control unit may be configured to maintain a temperature of the in-situ electrochemical cell in a variable temperature range of about −10° C. to about 80° C.

The in-situ electrochemical cell may include: a cell case having a plurality of holes through which X-rays irradiated from the X-ray analysis apparatus are transmitted into the in-situ electrochemical cell: an anode electrode provided in the cell case; a cathode electrode provided in the cell case; a separator arranged between the anode electrode and the cathode electrode; and an electrolyte wetted on at least surfaces of the anode electrode, the cathode electrode, and the separator.

The Peltier-type temperature control unit may further include a cover film attached on the pair of openings of the cap portion and allowing X-rays to pass while the in-situ electrochemical cell is maintained in a sealed environment.

The cover film may include a polymer material that is transparent and does not absorb X-rays.

The potentiostat may be further configured to provide information about the capacity, voltage, current, and time of the in-situ electrochemical cell to the controller, wherein the controller may be further configured to, in response to a signal based on the information provided by the potentiostat, provide a command signal for the X-ray analysis apparatus to irradiate X-rays to the in-situ electrochemical cell.

The controller may be further configured to derive overpotential information in each state based on the information about the capacity, voltage, current, and time of the in-situ electrochemical cell, wherein the controller may be further configured to determine a delay time during which a command signal is provided to the X-ray analysis apparatus according to the overpotential information.

The delay time may be determined to be a time until the overpotential information in each state becomes lower than a threshold overpotential.

The controller may be further configured to derive diffusivity information in each state based on the information about the capacity, voltage, current, and time of the in-situ electrochemical cell, wherein the controller may be further configured to determine a delay time during which a command signal is provided to the X-ray analysis apparatus according to the diffusivity information.

The delay time may be determined to be a time until the diffusivity information in each state becomes lower than a threshold diffusivity.

According to an aspect of the inventive concept of the present disclosure, there is provided an in-situ X-ray analysis method including: mounting an in-situ electrochemical cell in a Peltier-type temperature control unit, wherein the Peltier-type temperature control unit is connected to a controller and operates in a variable temperature range of about −10° C. to about 80° C.; and performing a plurality of in-situ X-ray analysis cycles on the in-situ electrochemical cell, wherein each of the plurality of in-situ X-ray analysis cycles includes: obtaining, by a potentiostat connected to the in-situ electrochemical cell, information about capacity, voltage, current, and time of the in-situ electrochemical cell; providing the information about the capacity, voltage, current, and time of the in-situ electrochemical cell from the potentiostat to the controller; deriving, by the controller, overpotential information or diffusivity information in each state of the in-situ electrochemical cell, based on the information about the capacity, voltage, current, and time; determining, by the controller, a delay time based on the overpotential information or the diffusivity information; providing a command signal from the controller to an X-ray analysis apparatus, connected to the controller, after the delay time has elapsed; and irradiating, by the X-ray analysis apparatus, X-rays to the in-situ electrochemical cell to obtain an X-ray diffraction pattern.

The Peltier-type temperature control unit may include: a base plate on which the in-situ electrochemical cell is mounted; a cap portion covering the in-situ electrochemical cell and having a pair of openings through which X-rays pass through the in-situ electrochemical cell; a temperature controller for heating or cooling the base plate; and a fluid supply line for supplying cooling water to a lower portion of the base plate.

The performing of the plurality of in-situ X-ray analysis cycles on the in-situ electrochemical cell may include: performing an in-situ X-ray analysis cycle during a charging process for the in-situ electrochemical cell at a first temperature; and performing an in-situ X-ray analysis cycle during a discharging process for the in-situ electrochemical cell at a second temperature different from the first temperature.

The first temperature and the second temperature may be determined considering a use environment of the in-situ electrochemical cell.

At least one of the first temperature and the second temperature may be in a range of about −10° C. to about 10° C.

The performing of the plurality of in-situ X-ray analysis cycles on the in-situ electrochemical cell may include: performing a plurality of first sub-cycles, wherein the plurality of first sub-cycles include performing an in-situ X-ray analysis cycle in a charging and discharging process for the in-situ electrochemical cell at a first temperature; and performing a plurality of second sub-cycles, wherein the plurality of second sub-cycles include performing an in-situ X-ray analysis cycle in a charging and discharging process for the in-situ electrochemical cell at a second temperature different from the first temperature.

The delay time may be determined to be a time until the overpotential information or the diffusivity information in each state of the in-situ electrochemical cell becomes lower than a threshold overpotential or a threshold diffusivity.

The delay time may be determined to be a constant value regardless of the overpotential information or the diffusivity information.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic diagram illustrating a representative configuration of an in-situ X-ray analysis apparatus according to embodiments;

FIG. 2 is an exploded perspective view of a Peltier-type temperature control unit in FIG. 1;

FIG. 3 is an exploded perspective view of an in-situ electrochemical cell in FIG. 1;

FIG. 4 is a flowchart illustrating an in-situ X-ray analysis method according to embodiments;

FIG. 5 is a flowchart of an in-situ X-ray analysis cycle exemplarily applied in the in-situ X-ray analysis method of FIG. 4;

FIG. 6 illustrates a temperature profile according to an in-situ analysis cycle exemplarily applied in the in-situ X-ray analysis method of FIG. 4;

FIG. 7 is a flowchart illustrating an in-situ X-ray analysis method according to embodiments;

FIG. 8 illustrates a temperature profile according to an in-situ analysis cycle exemplarily applied in the in-situ X-ray analysis method of FIG. 7;

FIGS. 9A to 9C illustrate voltage-capacity profiles at about 25° C., about 45° C., and about 5° C. of an in-situ electrochemical cell including LiCoO₂;

FIG. 10 illustrates results of in-situ X-ray analysis of a charge mode and a discharge mode, performed at about 25° C.;

FIG. 11 illustrates results of in-situ X-ray analysis of a charge mode and a discharge mode, performed at about 45° C.;

FIG. 12 illustrates results of in-situ X-ray analysis of a charge mode and a discharge mode, performed at about 5° C.;

FIG. 13A and FIG. 13D are voltage-capacity graphs of in-situ electrochemical cells including LiNi_{1/3}Co_{1/3}Mn_{1/3}O₂ and LiNi_{1/3}Co_{1/3}Mn_{1/3}O₂ with titanium introduced therein, respectively, at about 60° C.; FIG. 13B and FIG. 13C illustrate in-situ X-ray analysis results in an initial charging process of LiNi_{1/3}Co_{1/3}Mn_{1/3}O₂ at about 25° C. and about 60° C., respectively, and FIG. 13E and FIG. 13F illustrate in-situ X-ray analysis results in an initial charging process of LiNi_{1/3}Co_{1/3}Mn_{1/3}O₂ with titanium introduced therein at about 25° C. and about 60° C., respectively;

FIG. 14A and FIG. 14B are voltage-capacity graphs of electrochemical cells including anatase TiO₂ cathode active material at room temperature and about 60° C., respectively, and FIG. 14C and FIG. 14D are cyclic voltammogram (CV) graphs at room temperature and about 60° C., respectively;

FIG. 15A is a voltage profile during a first cycle at room temperature and about 60° C., FIG. 15B and FIG. 15C are in-situ X-ray analysis results during the first cycle at room temperature and about 60° C., respectively, and FIG. 15D is a schematic diagram of a lithium insertion model of anatase TiO₂;

FIG. 16A illustrates a voltage-capacity profile at 2 cycles, 20 cycles, and 40 cycles performed at about 60° C., and FIG. 16B schematically illustrates certain capacity in a first region and a second region;

FIG. 17A illustrates a voltage profile at 10 cycles and 20 cycles, and FIG. 17B and FIG. 17C are in-situ X-ray analysis results at 10 cycles and 20 cycles, respectively;

FIGS. 18A, 18B, and 18C are a coefficient of spherical aberration (Cs) corrected scanning transmission electron microscope (Cs-STEM) images of nanoparticles after 20 cycles at about 60° C.; FIG. 18D is a schematic diagram illustrating a degradation mode due to intra-crystal stress generation in an electrochemical cell; and

FIG. 19A is a graph showing cycle characteristics at room temperature, about 60° C., and about 90° C., and FIG. 19B is a graph showing cycle characteristics of a case in which 20 cycles are performed at about 60° C. and then 30 cycles are performed at room temperature.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

In order to fully understand the structure and effect of the present disclosure, embodiments of the present disclosure will be described with reference to the accompanying drawings. The present disclosure may, however, be embodied in many different forms and should not be construed as being limited to the embodiments set forth herein. These embodiments are provided so that the present disclosure will be thorough and complete, and will fully convey the concept of the disclosure to those skilled in the art. In the drawings, the thicknesses or sizes of elements are enlarged more than actual thicknesses or sizes for convenience of description, and the proportion of each element may be exaggerated or reduced.

It will be understood that when an element is referred to as being “on,” “connected to” or “coupled to” another element, it may be directly on, connected or coupled to other element or intervening elements may be present. In contrast, when an element is referred to being “directly on,” “directly connected to” or “directly coupled to” another element, there are no intervening elements present. Other words used to describe the relationship between elements should be interpreted in a like fashion (e.g., “between,” versus “directly between,” “adjacent,” versus “directly adjacent,” etc.).

While such terms as “first,” “second,” etc., may be used to describe various elements, such elements must not be limited to the above terms. The above terms are used only to distinguish one element from another. For example, a first element may be termed a second element, and, similarly, a second element may be termed a first element, without departing from the scope of the preset disclosure.

An expression used in the singular encompasses the expression of the plural, unless it has a clearly different meaning in the context. It will be understood that the terms “comprises,” “comprising,” “includes,” “including,” “have,” “having,” etc. when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms used herein have the same meanings as commonly understood by one of ordinary skill in the art to which embodiments belong.

Hereinafter, the present disclosure will be described in detail by describing embodiments of the present disclosure with reference to the accompanying drawings.

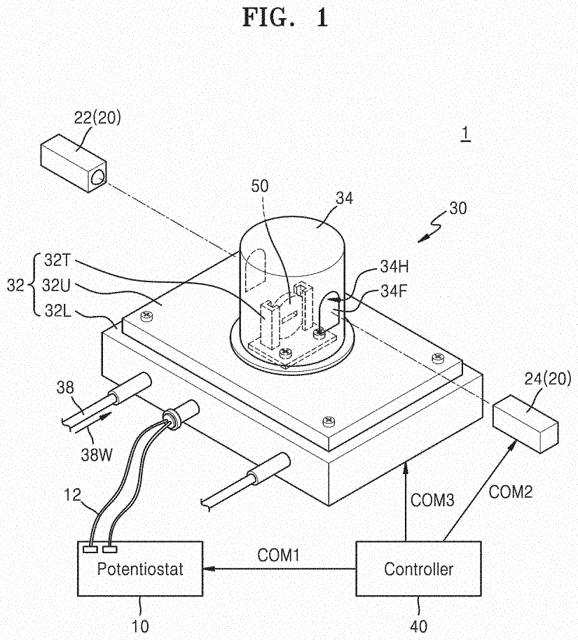

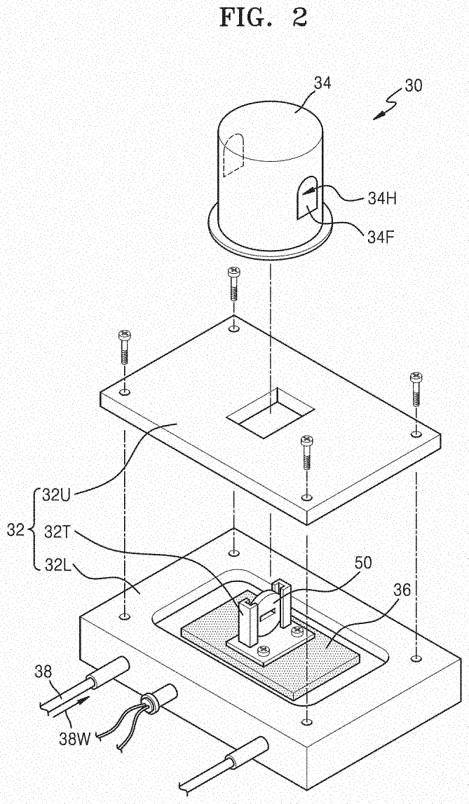

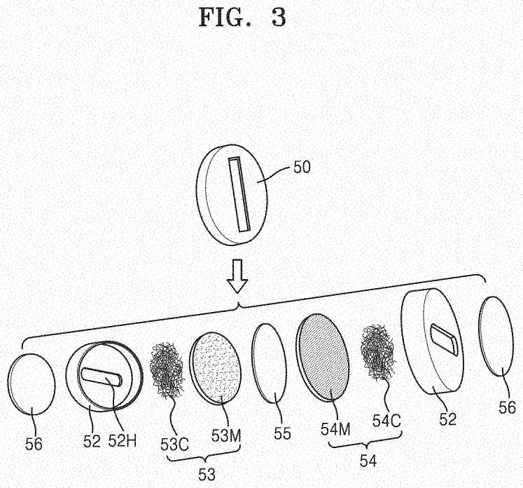

FIG. 1 is a schematic diagram illustrating a representative configuration of an in-situ X-ray analysis apparatus 1 according to embodiments. FIG. 2 is an exploded perspective view of a Peltier-type temperature control unit 30 in FIG. 1. FIG. 3 is an exploded perspective view of an in-situ electrochemical cell 50 in FIG. 1.

Referring to FIGS. 1 to 3, the in-situ X-ray analysis apparatus 1 may include a potentiostat 10, an X-ray analysis apparatus 20, the Peltier-type temperature control unit 30, and a controller 40.

In detail, the in-situ X-ray analysis apparatus 1 may include the potentiostat 10 capable of analyzing the electrochemical performance of the in-situ electrochemical cell 50, the X-ray analysis apparatus 20 capable of analyzing in-situ X-ray diffraction information for the in-situ electrochemical cell 50, and the Peltier-type temperature control unit 30 capable of mounting the in-situ electrochemical cell 50 therein. The controller 40 may be connected to the potentiostat 10, the X-ray analysis apparatus 20, and the Peltier-type temperature control unit 30, and may be configured to receive information from the potentiostat 10, the X-ray analysis apparatus 20, and the Peltier-type temperature control unit 30 and provide control signals to the potentiostat 10, the X-ray analysis apparatus 20, and the Peltier-type temperature control unit 30.

The potentiostat 10 may be connected to the in-situ electrochemical cell 50 and configured to control the voltage and current of the in-situ electrochemical cell 50 or to record voltage information and current information of the in-situ electrochemical cell 50. The potentiostat 10 may include input/output terminals 12 respectively connected to an anode terminal and a cathode terminal of the in-situ electrochemical cell 50. For example, a command signal COM1 may be provided from the controller 40 to the potentiostat 10, and in response to the command signal COM1, the potentiostat 10 may provide information about the capacity, voltage, current, and time of the in-situ electrochemical cell 50 to the controller 40.

The X-ray analysis apparatus 20 may be connected to the controller 40 and configured to irradiate X-rays to the in-situ electrochemical cell 50 and detect diffracted light from the in-situ electrochemical cell 50. The X-ray analysis apparatus 20 may include an X-ray irradiation unit 22 and an X-ray detection unit 24. For example, the X-ray analysis apparatus 20 may receive a command signal COM2 from the controller 40, and may be configured to irradiate X-rays to the in-situ electrochemical cell 50 in response to the command signal COM2 and detect diffracted light. In embodiments, the X-ray analysis apparatus 20 may be a transmission-type X-ray analysis apparatus. In other embodiments, the X-ray analysis apparatus 20 may be a reflection-type X-ray analysis apparatus.

The Peltier-type temperature control unit 30 may be configured to mount the in-situ electrochemical cell 50 therein and maintain the in-situ electrochemical cell 50 within a controlled temperature condition. The Peltier-type temperature control unit 30 may be connected to the controller 40 and receive a command signal COM3, and may adjust the temperature of the in-situ electrochemical cell 50 in response to the command signal COM3. For example, the Peltier-type temperature control unit 30 may be configured to maintain the temperature of the in-situ electrochemical cell 50 in a variable temperature range of about −10° C. to about 80° C. The Peltier-type temperature control unit 30 may precisely control the temperature of the in-situ electrochemical cell 50 through cooling or heating of the in-situ electrochemical cell 50, and allows to perform in-situ X-ray analysis on the in-situ electrochemical cell 50 under controlled temperature conditions.

In embodiments, the Peltier-type temperature control unit 30 may include a base plate 32, a cap portion 34, a temperature controller 36, and a fluid supply line 38.

The base plate 32 may mount the in-situ electrochemical cell 50 thereon. The base plate 32 may be capable of performing temperature control with respect to the in-situ electrochemical cell 50 of a coin type and may serve as a cell holder capable of holding the in-situ electrochemical cell 50 at an angle at which X-rays may be irradiated from the X-ray analysis apparatus 20 (for example, in a vertical direction from the base plate 32).

In some embodiments, as shown in FIG. 1, the base plate 32 may include a lower plate 32L, an upper plate 32U, and a top holder 32T. The upper plate 32U may be coupled to the lower plate 32L by a fastening member such as a screw, and the temperature controller 36 may be arranged in a space between the upper plate 32U and the lower plate 32L. The top holder 32T may be arranged on the temperature controller 36, and the in-situ electrochemical cell 50 may be mounted on the top holder 32T. The top holder 32T may further include an anode terminal and a cathode terminal, and current may be applied to the in-situ electrochemical cell 50 by the anode terminal and the cathode terminal of the top holder 32T. The upper plate 32U may have an opening (not shown) through which the top holder 32T and the in-situ electrochemical cell 50 may protrude onto the upper plate 32U.

The cap portion 34 may be mounted on the base plate 32 to cover the in-situ electrochemical cell 50. The cap portion 34 may have a pair of openings 34H, and X-rays irradiated from the X-ray irradiation unit 22 of the X-ray analysis apparatus 20 may pass through the in-situ electrochemical cell 50 through the pair of openings 34H and be incident back onto the X-ray detection unit 24 of the X-ray analysis apparatus 20.

A cover film 34F may be arranged on the pair of openings 34H. The cover film 34F may be attached on the pair of openings 34H and isolate a space inside the cap portion 34 from a space outside the cap portion 34 so that the in-situ electrochemical cell 50 may be maintained in a sealed environment. In addition, the cover film 34F may be thin and transparent so that X-rays may pass therethrough. For example, the cover film 34F may include a polymer material having a relatively low X-ray absorbance. For example, as the cover film 34F, SpectroFilm®, Etnom®, etc. available from Chemplex Industries Inc. (USA) may be used.

The temperature controller 36 may be configured to heat or cool the base plate 32 and the in-situ electrochemical cell 50 mounted on the base plate 32. For example, the temperature controller 36 may be a thermal plate configured to heat or cool the base plate 32. In some embodiments, the temperature controller 36 may be arranged in a space between the lower plate 32L and the upper plate 32U of the base plate 32.

In embodiments, the temperature controller 36 may include a Peltier-type thermoelectric element. The Peltier-type thermoelectric element may control the temperature of an object of the Peltier-type thermoelectric element by cooling or heating the object according to the direction of flowing current. In particular, the Peltier-type thermoelectric element operates on the principle that an n-type semiconductor element and a p-type semiconductor element are arranged between metal electrodes and heat is radiated from or absorbed by the metal electrodes according to a current flow direction. For example, when the current temperature of the object is lower than a target temperature, a forward current flows, and thus, heat is radiated from the metal electrodes to heat the object. Conversely, when the current temperature of the object is higher than the target temperature, a reverse current flows, and thus, heat is absorbed by the metal electrodes to cool the object. The Peltier-type thermoelectric element may quickly and precisely control the temperature of the object by adjusting the direction and magnitude of current. For example, the temperature controller 36 may precisely control the temperature of the base plate 32 in a temperature range of about −10° C. to about 80° C.

The fluid supply line 38 may be configured to supply a cooling water 38 W to a lower portion of the base plate 32. The fluid supply line 38 may be configured to pass through a space between the lower plate 32L and the upper plate 32U of the base plate 32 to rapidly cool the base plate 32. However, the arrangement of the fluid supply line 38 is not essential, and in other embodiments, the fluid supply line 38 may be omitted.

The controller 40 may be electrically connected to the potentiostat 10, the X-ray analysis apparatus 20, and the Peltier-type temperature control unit 30. The controller 40 may receive information about capacity, voltage, current, and time from the potentiostat 10 and provide the command signal COM2 to the X-ray analysis apparatus 20 in response to a signal based on the information. The controller 40 may provide the command signal COM3 to the Peltier-type temperature control unit 30 and adjust the temperature of the Peltier-type temperature control unit 30 to a set temperature in a charge mode or a discharge mode.

For example, the controller 40 may be configured to derive overpotential information and diffusivity information in each state based on the information about capacity, voltage, current, and time provided from the potentiostat 10. In addition, the controller 40 may derive a delay time based on the overpotential information and the diffusivity information and provide the command signal COM2 to the X-ray analysis apparatus 20 after the delay time has elapsed. As the controller 40 adjusts the delay time according to a reaction rate of the in-situ electrochemical cell 50, an X-ray diffraction analysis may be performed in a quasi-equilibrium state of the in-situ electrochemical cell 50. In addition, the controller 40 may be configured to measure the electrochemical performance of the in-situ electrochemical cell 50 through a cycle including a charge mode at a set temperature and a discharge mode at a set temperature.

As shown in FIG. 3, the in-situ electrochemical cell 50 may include a cell case 52, a cathode electrode 53, an anode electrode 54, a separator 55, a protection member 56, and an electrolyte (not shown).

The cell case 52 may include at least one hole 52H in the upper surface and the lower surface thereof. X-rays irradiated from the X-ray analysis apparatus 20 through the at least one hole 52H of the cell case 52 may be transmitted into the in-situ electrochemical cell 50. In embodiments, the cell case 52 may include a coin-type metal case in which a plurality of holes 52H are formed in the upper surface thereof. However, the shape and material of the cell case 52 is not limited thereto. Unlike in FIG. 3, the cell case 52 may include a rectangular-type metal case in which at least one hole 52H is formed in the upper surface thereof.

In embodiments, the protection member 56 covering the upper surfaces of the plurality of holes 52H of the cell case 52 may be formed. The protection member 56 may be, for example, transparent adhesive tape. The protection member 56 may prevent the electrolyte from leaking out of the cell case 52.

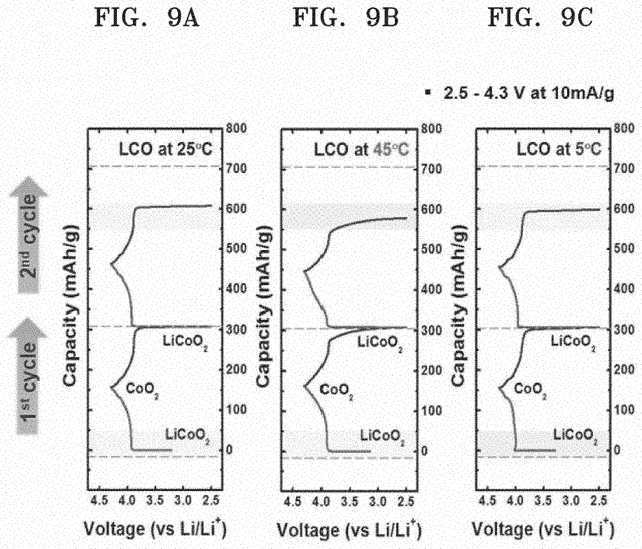

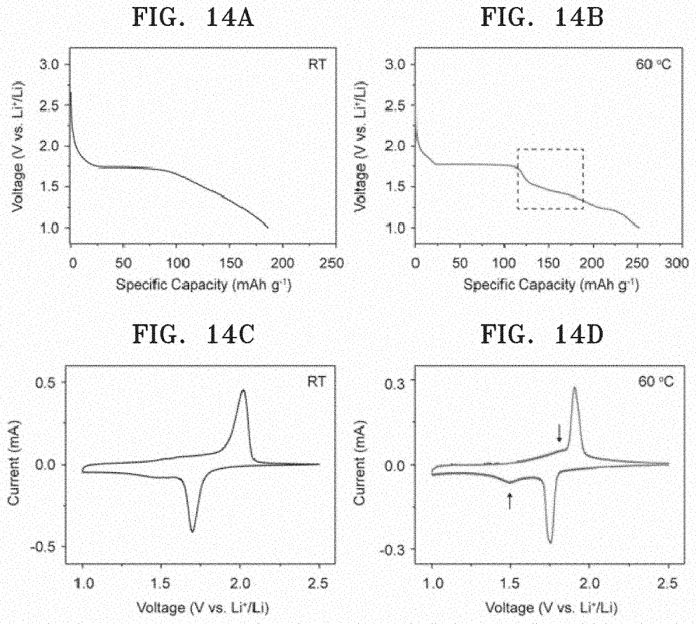

The cathode electrode 53 may include a cathode current collector 53C and a cathode active material 53M. The cathode current collector 53C may include a conductive material, and may be a carbon fiber structure, a thin conductive mesh, or a thin conductive foil. For example, the cathode current collector 53C may include carbon paper, carbon cloth, aluminum, nickel, copper, gold, or an alloy thereof. The cathode active material 53M may include a material capable of reversibly inserting/deinserting lithium ions. The cathode active material 53M may be an active material required to analyze phase transition characteristics according to charging and discharging by the potentiostat 10 and the X-ray analysis apparatus 20. In embodiments, the cathode active material 53M may include an olivine-structured lithium phosphate-based cathode active material, a vanadium oxide-based cathode active material, layered lithium metal oxides, a spinel-structured lithium manganese oxide-based cathode active material, a sulfur-based cathode active material, a selenium-based cathode active material, or the like. For example, the cathode active material 53M may include LiFePO₄, LiMnₓFe₁₋ₓPO₄, LiFePO₄F, V₂O₅, LiV₂O₅, LiMnO₂, LiCoO₂, LiNiₓMn_{y}Co_{1-x-y}O₂, LiMn₂O₄, S, Se, or the like. For example, results obtained by analyzing, through the in-situ X-ray analysis apparatus 1, the electrochemical performance and microstructure of the in-situ electrochemical cell 50 using LiCoO₂ or LiNi_{1/3}Co_{1/3}Mn_{1/3}O₂ as the cathode active material 53M are described in detail with reference to FIGS. 9 to 13. In addition, results obtained by analyzing, through the in-situ X-ray analysis apparatus 1, the electrochemical performance and microstructure of the in-situ electrochemical cell 50 using anatase TiO₂ as an anode active material 54M are described in detail with reference to FIGS. 14A to 19B.

Although not shown, a binder or a conductive material may be further included in the cathode active material 53M. The binder may attach particles of the cathode active material 53M to each other and attach the cathode active material 53M to the cathode current collector 53C. The conductive material may provide electrical conductivity to the cathode active material 53M.

The anode electrode 54 may include an anode current collector 54C and an anode active material 54M. The anode current collector 54C may include a conductive material, and may be a carbon fiber structure, a thin conductive mesh, or a thin conductive foil. For example, the anode current collector 54C may include carbon paper, carbon cloth, copper, nickel, aluminum, gold, or an alloy thereof. The anode active material 54M may include a material capable of reversibly intercalating/deintercalating lithium ions. The anode active material 54M may be an active material required to analyze phase transition characteristics according to charging and discharging by the potentiostat 10 and the X-ray analysis apparatus 20. In embodiments, the anode active material 54M may include a carbon-based anode active material, a graphite-based anode active material, a silicon-based anode active material, a tin-based anode active material, a composite anode active material, a lithium metal anode active material, anatase titanium oxide, vanadium oxide, or the like.

Although not shown, a binder or a conductive material may be further included in the anode active material 54M. The binder may attach particles of the anode active material 54M to each other and attach the anode active material 54M to the anode current collector 54C. The conductive material may provide electrical conductivity to the anode active material 54M.

The separator 55 may have porosity, and may include a single membrane or a multi-layered membrane having two or more layers. The separator 55 may include a polymer material, for example, at least one of polyethylene-based polymer, polypropylene-based polymer, polyvinylidene fluoride-based polymer, polyolefin-based polymer, and the like.

The electrolyte (not shown) may be formed on the surfaces of the cathode electrode 53, the anode electrode 54, and the separator 55. For example, a stacked structure of the cathode electrode 53, the anode electrode 54, and the separator 55 may be immersed in the electrolyte and then arranged in the cell case 52. The electrolyte may include a non-aqueous solvent and an electrolyte salt. The non-aqueous solvent is not particularly limited as long as the non-aqueous solvent is used as a non-aqueous solvent for a general non-aqueous electrolyte. For example, the non-aqueous solvent may include a carbonate-based solvent, an ester-based solvent, an ether-based solvent, a ketone-based solvent, an alcohol-based solvent, or an aprotic solvent. The non-aqueous solvent may be used alone or in combination of one or more thereof, and when one or more non-aqueous solvents are mixed and used, a mixing ratio may be appropriately adjusted according to a desired battery performance.

According to the in-situ X-ray analysis apparatus 1 according to the embodiments of the present disclosure, the electrochemical performance and microstructure of the in-situ electrochemical cell 50 may be precisely analyzed by the controller 40 in a variable temperature range of about −10° C. to about 80° C., the controller 40 being connected to all of the potentiostat 10, the X-ray analysis apparatus 20, and the Peltier-type temperature control unit 30.

In general, an in-situ X-ray analysis apparatus performs X-ray diffraction analysis multiple times at regular time intervals on an electrochemical cell, and may obtain information about the microstructure of an active material by arranging analysis data in chronological order. However, when X-ray diffraction analysis is performed at regular time intervals, in an electrochemical cell including an active material having a slow reaction rate, X-ray diffraction analysis data is obtained in a state where it does not reach an equilibrium state, and thus, it is difficult to precisely analyze the actual microstructure of the active material.

However, according to the in-situ X-ray analysis apparatus 1 according to the embodiments of the present disclosure, the controller 40 may receive information about capacity, voltage, current, and time from the potentiostat 10, derive a delay time based on overpotential information and diffusivity information in response to a signal based on the information, and provide a command signal to the X-ray analysis apparatus 20 after the delay time has elapsed. Therefore, the in-situ X-ray analysis apparatus 1 may perform X-ray diffraction analysis in a quasi-equilibrium state of the in-situ electrochemical cell 50, and thus, may precisely analyze microstructural characteristics and phase transition characteristics such as crystal phase, lattice constant, and volume.

In addition, in general, an electrochemical cell assembled together with an integrated circuit in a mobile device tends to be repeatedly used at a relatively high temperature due to heat generated by the operation of the integrated circuit. An electrochemical cell used in a battery system of an electric vehicle tends to be used under various temperature conditions, such as periodic repetition of low and high temperatures, at a low or high temperature due to external environments such as seasonal changes. However, because research to improve the performance of an active material of the electrochemical cell is mainly conducted at room temperature, the relationship between the microstructure of the active material and the electrochemical performance thereof according to charging and discharging in a use environment of the electrochemical cell has not been clearly identified, or whether a certain microstructure change occurs according to charging and discharging under certain temperature conditions has not been clearly identified, and thus, performance improvement and commercialization of candidate materials are becoming difficult.

In the in-situ X-ray analysis apparatus 1 according to the embodiments of the present disclosure, the controller 40 may control the Peltier-type temperature control unit 30 to perform the charging and discharging of the in-situ electrochemical cell 50 within a temperature range of about −10° C. to about 80° C. Therefore, in order to simulate the capability of stable operation under various temperature conditions that vary depending on the application of the electrochemical cell, the microstructure of an anode active material or a cathode active material under variable and repetitive temperature conditions including low temperatures may be precisely analyzed.

In addition, because the in-situ X-ray analysis apparatus 1 according to the embodiment of the present disclosure may precisely control the temperature of the in-situ electrochemical cell 50 by using the temperature controller 36 of a Peltier type, the in-situ X-ray analysis apparatus 1 may have a relatively compact size. In particular, because installation of a coolant line that requires an external chiller is unnecessary, the in-situ X-ray analysis apparatus 1 may be used in conjunction with a bench-top scale X-ray diffraction apparatus having a relatively small size.

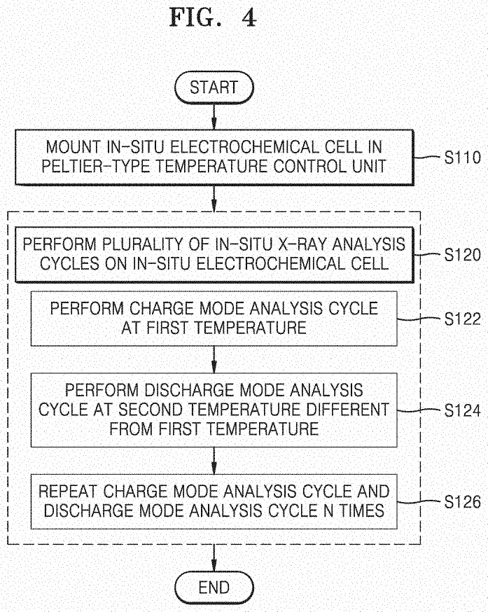

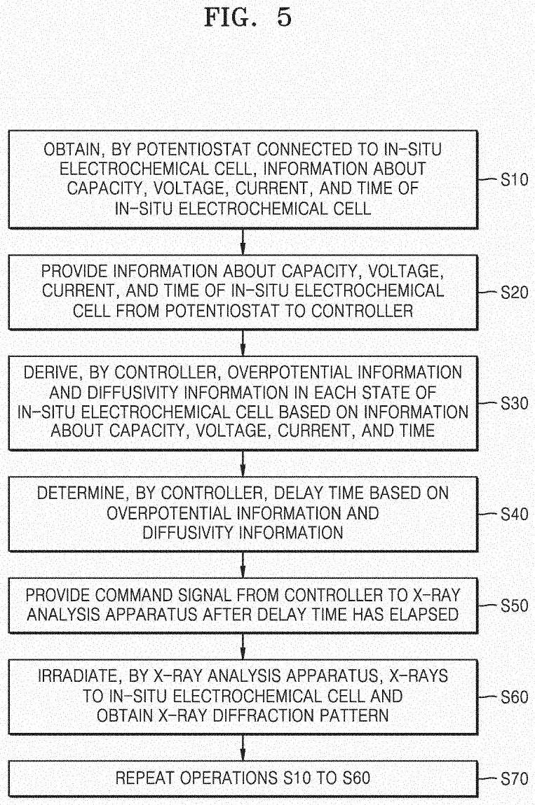

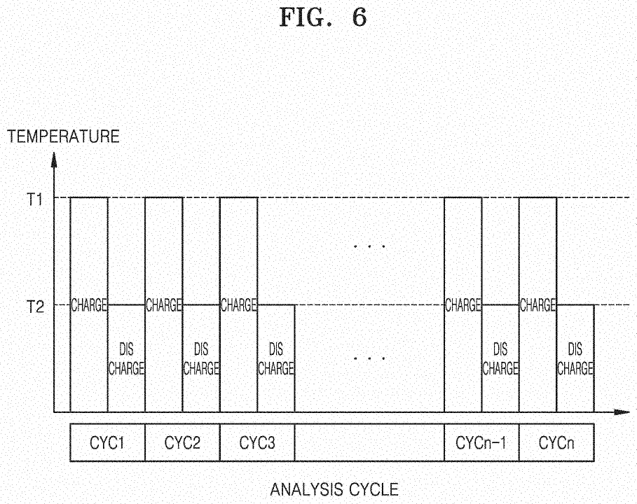

FIG. 4 is a flowchart illustrating an in-situ X-ray analysis method according to embodiments. FIG. 5 is a flowchart of an in-situ X-ray analysis cycle exemplarily applied in the in-situ X-ray analysis method of FIG. 4. FIG. 6 illustrates a temperature profile according to an in-situ analysis cycle exemplarily applied in the in-situ X-ray analysis method of FIG. 4.

Referring to FIGS. 4 to 6, the in-situ electrochemical cell 50 may be mounted in the Peltier-type temperature control unit 30 (operation S110).

In embodiments, the in-situ electrochemical cell 50 may be mounted in the top holder 32T of the base plate 32, and the cap portion 34 may be fixedly installed on the upper plate 32U to cover the in-situ electrochemical cell 50. The in-situ electrochemical cell 50 may be arranged in a space defined by the cap portion 34 and the upper plate 32U, and thus may be maintained in a sealed atmosphere from an external environment.

Thereafter, a plurality of in-situ X-ray analysis cycles may be performed on the in-situ electrochemical cell 50 (operation S120).

In embodiments, the plurality of in-situ X-ray analysis cycles may include performing a charge mode analysis cycle at a first temperature T1 (operation S122), performing a discharge mode analysis cycle at a second temperature T2 that is different from the first temperature T1 (operation S124), and repeating the charge mode analysis cycle and the discharge mode analysis cycle n times (operation S126).

For example, as shown in FIG. 6, a plurality of analysis cycles CYC1, CYC2, CYC3, . . . CYCn−1, and CYCn may be set to repeatedly perform charging at the first temperature T1 and discharging at the second temperature T2. In some examples, the first temperature T1 may be in a temperature range of about 10° C. to about 30° C., and the second temperature T2 may be in a temperature range of about −10° C. to about 10° C. In another example, the first temperature T1 may be in a temperature range of about 10° C. to about 30° C., and the second temperature T2 may be in a temperature range of about 20° C. to about 50° C. In another example, the first temperature T1 may be in a temperature range of about 20° C. to about 50° C., and the second temperature T2 may be in a temperature range of about 20° C. to about 50° C.

The first temperature T1 and the second temperature T2 may be determined considering a use environment according to an application of the in-situ electrochemical cell 50. For example, for use in a battery system of an electric vehicle, iterative analysis of a charge mode at room temperature of about 10° C. to about 30° C. and a discharge mode at a low temperature of about −10° C. to about 10° C. may be performed. For example, for use in a mobile device, iterative analysis of a charge mode at room temperature of about 10° C. to about 30° C. and a discharge mode at a high temperature of about 20° C. to about 50° C. may be performed.

Each in-situ X-ray analysis cycle is described with reference to the flowchart shown in FIG. 5. As shown in FIG. 5, information about the capacity, voltage, current, and time of the in-situ electrochemical cell 50 may be obtained by the potentiostat 10 connected to the in-situ electrochemical cell 50 (operation S10).

In embodiments, a unit charging operation or unit discharging operation using a relatively low current density in the in-situ electrochemical cell 50 may be performed through the potentiostat 10 by using a current density previously input to the controller 40 in operation S10. For example, the in-situ electrochemical cell 50 may be prepared using the cathode active material 53M including LiCoO₂ and the anode active material 54M including lithium metal, and during the unit charging operation, a current may be applied to the in-situ electrochemical cell 50 by using a current density of 0.01 C for 1 hour. In this case, 1 C indicates a current density at which 100% charging may be completed using a constant current density for a total of 1 hour with respect to the total mass of the cathode active material 53M, and 0.01 C indicates a current density at which 100% charging may be completed for a total of 100 hours with respect to the total mass of the cathode active material 53M.

Thereafter, the information about the capacity, voltage, current, and time of the in-situ electrochemical cell 50 may be provided from the potentiostat 10 to the controller 40 (operation S20).

In embodiments, operation S10 of obtaining the information about the capacity, voltage, current, and time of the in-situ electrochemical cell 50 by using the potentiostat 10, and operation S20 of providing the information about the capacity, voltage, current, and time to the controller 40 may be performed substantially simultaneously.

In other embodiments, operation S10 of obtaining the information about the capacity, voltage, current, and time of the in-situ electrochemical cell 50 by using the potentiostat 10 may be first performed, and after a certain first transmission delay time, operation S20 of providing the information about the capacity, voltage, current, and time to the controller 40 may be performed. The first transmission delay time may be in the range of about 0.01 seconds to about 1 minute. For example, in operation S10, a constant current may be applied to the in-situ electrochemical cell 50 by using a current density of 0.01 C, while voltage information of the in-situ electrochemical cell 50 may be detected and recorded at intervals of about 0.1 seconds. The voltage information of the in-situ electrochemical cell 50 may be transmitted to the controller 40 after the first transmission delay time.

Then, based on the information about the capacity, voltage, current, and time, the controller 40 may derive overpotential information and diffusivity information in each state of the in-situ electrochemical cell 50 (operation S30).

In embodiments, the overpotential information of the in-situ electrochemical cell 50 may be determined to be a difference between a cutoff voltage and an open circuit voltage. For example, the overpotential information may be information related to a polarization state applied to a cathode electrode due to the characteristic that lithium ion diffusivity is lower than the electron conductivity of the cathode electrode.

Also, the diffusivity information of the in-situ electrochemical cell 50 may be determined from Equation (1) below, that is, the Weppner and Huggins equation.

$${D}_{GITT} = \frac{4}{π} {( \frac{mV}{MS} )}^{2} {( \frac{Δ {E}_{z}}{τ ( {dE}_{τ} / d \sqrt{τ}} )}^{2} ; τ < {L}^{2} {D}_{GITT} \qquad ( 1 )$$

In Equation (1), V is the molar volume (cm³/mol) of a compound, T is the duration of a current pulse in seconds, and M and m are the molecular weight (g/mol) and mass (g) of LiMnₓFe₁₋ₓPO₄. In addition, S is an interface area (cm²) between an active material and an electrolyte, and L is a diffusion length (cm). ΔE_{T} and ΔE_{S} are a voltage change value after iR drop (e.g., a voltage drop) is applied and a voltage change value after a retention time has elapsed, respectively.

In embodiments, in operation S30, based on the information about the capacity, voltage, current, and time, the controller 40 may also derive ohmic polarization information in each state of the in-situ electrochemical cell 50. The ohmic polarization information may be information related to a sudden change in voltage at the beginning of each operation, for example, information related to iR drop (or a voltage drop) in the in-situ electrochemical cell 50.

Thereafter, the controller 40 may determine a delay time based on the overpotential information and the diffusivity information (operation S40).

In embodiments, the delay time may be determined to be a time until the overpotential information and the diffusivity information in each state become lower than a threshold overpotential and a threshold diffusivity. For example, the delay time may be determined to be a time during which the overvoltage information becomes lower than a threshold overpotential. Alternatively, the delay time may be determined to be a time during which the diffusivity information becomes lower than a threshold diffusivity.

In other embodiments, the delay time may be determined to be a constant time regardless of (or independent of) the overpotential information and the diffusivity information in each state.

According to operation S40, the delay time may vary according to the reaction rate of the anode active material or the cathode active material of the in-situ electrochemical cell 50. For example, when an overpotential in the in-situ electrochemical cell 50 is higher than a threshold overpotential, the delay time may increase. The threshold overpotential may be a value predetermined according to the type of the anode active material or the cathode active material to be analyzed.

Thereafter, after the delay time has elapsed, a command signal may be provided from the controller 40 to the X-ray analysis apparatus 20 connected to the controller 40 (operation S50).

Thereafter, the X-ray analysis apparatus 20 may obtain an X-ray diffraction pattern by irradiating X-rays to the in-situ electrochemical cell 50 (operation S60). In embodiments, X-rays may be irradiated from the X-ray irradiation unit 22 of the X-ray analysis apparatus 20 through at least one hole 52H provided in the cell case 52 of the in-situ electrochemical cell 50, and transmitted X-rays may be detected by the X-ray detection unit 24.

Thereafter, operations S10 to S60 may be repeated (operation S70).

For example, sequentially performing operations S10 to S60 may constitute a unit charging operation or a unit discharging operation. The in-situ X-ray analysis method according to the embodiments may include a total of ten to several hundred unit charging operations and/or a total of ten to several hundred unit discharging operations.

According to the above-described embodiments, as an X-ray diffraction pattern is obtained after the delay time, precise matching and analysis between electrochemical data (i.e., items related to capacity or voltage) of the in-situ electrochemical cell 50 and the X-ray diffraction pattern (i.e., items related to microstructure) may be realized.

For example, in the case of the in-situ electrochemical cell 50 using a cathode active material 53M including LiMnₓFe₁₋ₓPO₄, which has a relatively low reaction rate, when using an existing method of performing X-ray diffraction analysis at regular time intervals while performing charging or discharging by using a general charging/discharging device, it may be difficult to accurately check a microstructure. In particular, the cathode active material 53M including LiMnₓFe₁₋ₓPO₄ may have a relatively high overpotential due to charging and discharging, compared to a conventional cathode active material, and a difference between an external voltage detected at both external terminals of the in-situ electrochemical cell 50 and an internal voltage actually applied to particles of the cathode active material 53M in the in-situ electrochemical cell 50 may be significant due to the high overpotential. In this case, when performing X-ray diffraction analysis by using an existing method, it may be difficult to clearly match a microstructure according to the voltage of the cathode active material 53M.

In addition, anode active materials such as anatase TiO₂ are in the spotlight as materials capable of fast charging, but may have a problem in that a difference between electrochemical performance at room temperature and electrochemical performance at a high temperature is relatively large, or severe deterioration occurs at a high temperature. Therefore, when performing X-ray diffraction analysis at room temperature by using a conventional method, it may be difficult to clearly identify phase transition characteristics at high temperatures.

On the contrary, according to the present disclosure, the controller 40 may derive overpotential information and diffusivity information based on information in each state, a delay time may be determined based on the overpotential information and the diffusivity information, and a command signal may be provided to the X-ray analysis apparatus 20 after the delay time has elapsed. For example, the delay time may be determined to be a time until the overpotential information becomes lower than a threshold overpotential. For example, the delay time may be a time until, in each state, a difference between an external voltage of the in-situ electrochemical cell 50 and an internal voltage applied to the cathode active material 53M becomes lower than a threshold overpotential, that is, until a difference between an external voltage of the in-situ electrochemical cell 50 and an internal voltage applied to the cathode active material 53M has a significantly reduced value.

The delay time may be determined differently in each state (i.e., at different voltage values or at each unit charging operation or unit discharging operation). Alternatively, the delay time may be determined to be the same value in each state.

In addition, according to the present disclosure, because the temperature of each of the charge mode and the discharge mode may be precisely controlled by the Peltier-type temperature control unit 30 interlocked with the controller 40, electrochemical performance and phase transition characteristics at a certain temperature may be precisely analyzed for an active material having a lifetime degradation mechanism at a certain temperature, such as anatase TiO₂.

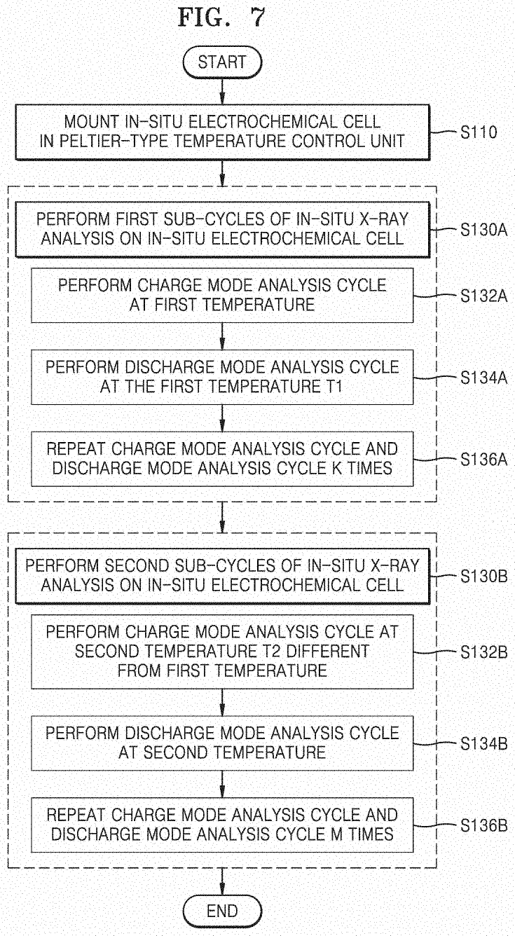

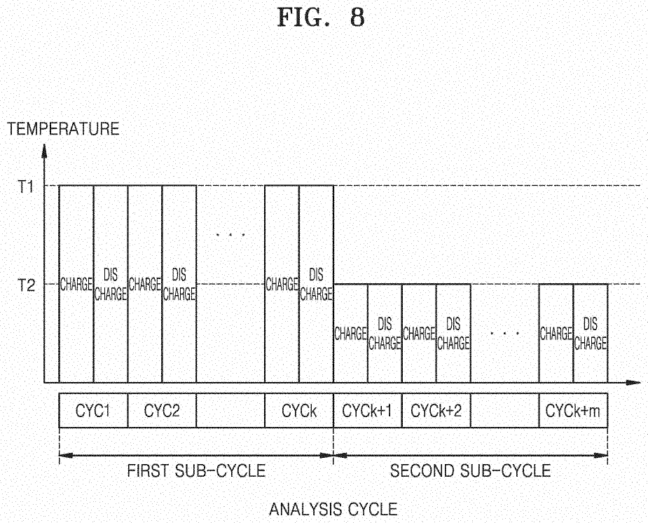

FIG. 7 is a flowchart illustrating an in-situ X-ray analysis method according to embodiments. FIG. 8 illustrates a temperature profile according to an in-situ analysis cycle exemplarily applied in the in-situ X-ray analysis method of FIG. 7.

Referring to FIGS. 7 and 8, the in-situ electrochemical cell 50 may be mounted in the Peltier-type temperature control unit 30 (operation S110).

Thereafter, first sub-cycles of an in-situ X-ray analysis may be performed on the in-situ electrochemical cell (operation 5130A).

In embodiments, first sub-cycles of in-situ X-ray analyses may include performing a charge mode analysis cycle at a first temperature T1 (operation S132A), performing a discharge mode analysis cycle at the first temperature T1 (operation S134A), and repeating the charge mode analysis cycle and the discharge mode analysis cycle k times (operation S136A).

Thereafter, second sub-cycles of the in-situ X-ray analysis may be performed on the in-situ electrochemical cell (operation S130B).

In embodiments, second sub-cycles of the plurality of in-situ X-ray analyses may include performing a charge mode analysis cycle at a second temperature T2 that is different from the first temperature T1 (operation S132B), performing a discharge mode analysis cycle at the second temperature T1 (operation S134B), and repeating the charge mode analysis cycle and the discharge mode analysis cycle m times (operation S136B). The number of repetitions k and m may each range from 1 to 100, but is not limited thereto.

For example, as shown in FIG. 8, first sub-cycles CYC1, CYC2, CYC3, . . . , and CYCk may be set to repeatedly perform charging at the first temperature T1 and discharging at the first temperature T1. Second sub-cycles CYCk+1, CYCk+2, . . . , and CYCk+m may be set to repeatedly perform charging at the second temperature T2 and discharging at the second temperature T2.

In some examples, the first temperature T1 may be in a temperature range of about 10° C. to about 30° C., and the second temperature T2 may be in a temperature range of about −10° C. to about 10° C. In another example, the first temperature T1 may be in a temperature range of about 10° C. to about 30° C., and the second temperature T2 may be in a temperature range of about 20° C. to about 50° C. In another example, the first temperature T1 may be in a temperature range of about 20° C. to about 50° C., and the second temperature T2 may be in a temperature range of about 20° C. to about 50° C.

The first temperature T1 and the second temperature T2 may be determined considering a use environment according to an application of the in-situ electrochemical cell 50. For example, for use in a battery system of an electric vehicle, a charge mode and a discharge mode at room temperature of about 10° C. to about 30° C. may be repeatedly performed during a first sub-cycle, and a charge mode and a discharge mode at a low temperature of about −10° C. to about 10° C. may be repeatedly performed during a second sub-cycle.

Hereinafter, an in-situ X-ray analysis result of the in-situ electrochemical cell 50 using LiCoO₂ as a cathode active material is described with reference to FIGS. 9A to 12.

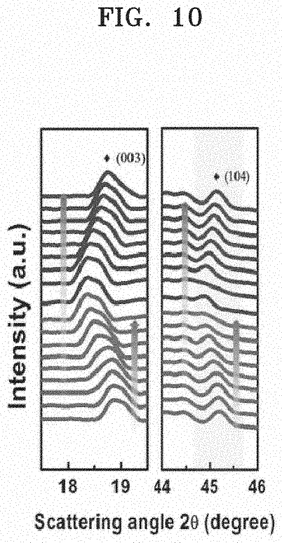

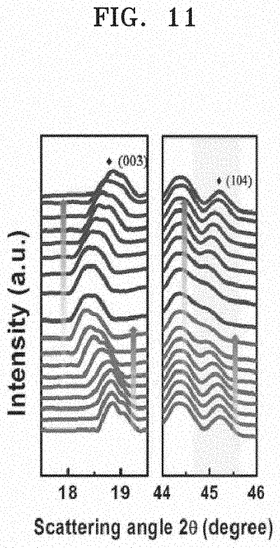

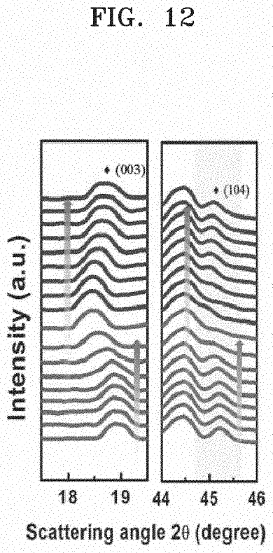

FIGS. 9A to 9C illustrates voltage-capacity profiles at 25° C., 45° C., and 5° C. of an in-situ electrochemical cell including LiCoO₂ (represented as LCO in the drawings). FIG. 10 illustrates results of in-situ X-ray analysis of a charge mode and a discharge mode, performed at about 25° C. FIG. 11 illustrates results of in-situ X-ray analysis of a charge mode and a discharge mode, performed at about 45° C. FIG. 12 illustrates results of in-situ X-ray analysis of a charge mode and a discharge mode, performed at about 5° C.

As shown in FIG. 9B, a voltage plateau area develops relatively small in the second discharge cycle at about 45° C., whereby the discharge capacity in the second discharge cycle is reduced by approximately 10% compared to the discharge capacity at about 25° C. as shown in FIG. 9A. Also, as shown in FIG. 11, according to the in-situ X-ray analysis results at about 45° C., a shoulder peak of a (003) peak is observed in the discharge mode (or a split phenomenon of the (003) peak is observed), and a (104) peak is observed with a relatively large intensity in the discharge mode.

On the other hand, as shown in FIG. 9C, an abnormal bending occurs in the voltage plateau area at the beginning of the first charge cycle at about 5° C., which is presumed to be due to relatively low initial lithium ion mobility at a low temperature. Also, as shown in FIG. 11, according to the in-situ X-ray analysis results at about 45° C., the behaviors of the (003) peak and the (104) peak in the discharge mode are similar to that at about 25° C.

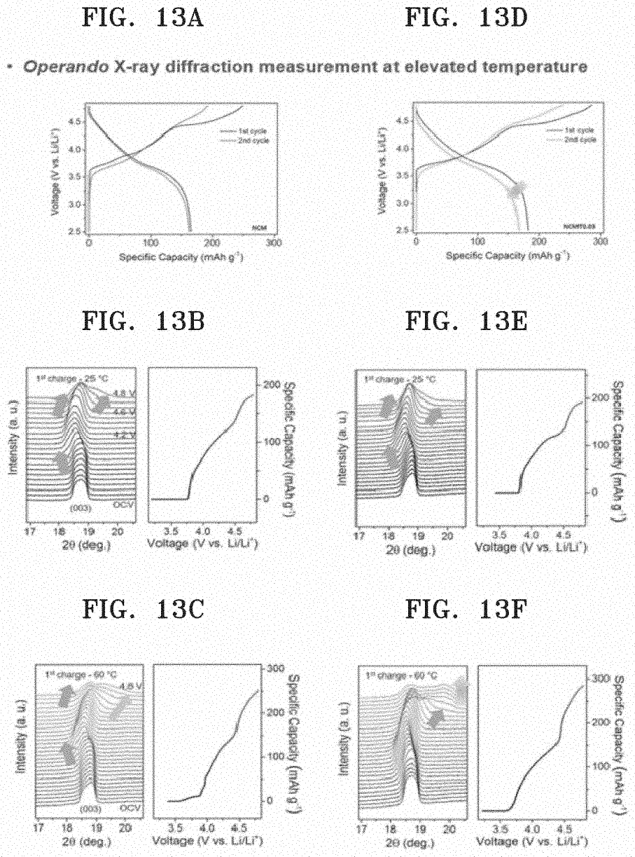

In-situ X-ray analysis results of the in-situ electrochemical cell 50 using, as cathode active materials, LiNi_{1/3}Co_{1/3}Mn_{1/3}O₂ and LiNi_{1/3}Co_{1/3}Mn_{1/3}O₂ with titanium introduced therein are described below with reference to FIGS. 13A to 13D.

FIG. 13A and FIG. 13D are voltage-capacity graphs of in-situ electrochemical cells using, as cathode active materials, LiNi_{1/3}Co_{1/3}Mn_{1/3}O₂ (represented as NCM in FIG. 13A) and LiNi_{1/3}Co_{1/3}Mn_{1/3}O₂ with titanium introduced therein (represented as NCMT0.03 in FIG. 13D), respectively, at about 60° C. FIG. 13B and FIG. 13C illustrate in-situ X-ray analysis results in an initial charging process of LiNi_{1/3}Co_{1/3}Mn_{1/3}O₂ at about 25° C. and about 60° C., respectively, and FIG. 13E and FIG. 13F illustrate in-situ X-ray analysis results in an initial charging process of LiNi_{1/3}Co_{1/3}Mn_{1/3}O₂ with titanium introduced therein at about 25° C. and about 60° C., respectively.

Referring to FIGS. 13A to 13F, particles of LiNi_{1/3}Co_{1/3}Mn_{1/3}O₂ and particles of LiNi_{1/3}Co_{1/3}Mn_{1/3}O₂ with titanium introduced therein are prepared using a carbonate co-precipitation synthesis method, and a test is conducted using the particles as cathode active materials. As a result of a cycle test at about 60° C., it is confirmed that the stability of a cell using LiNi_{1/3}Co_{1/3}Mn_{1/3}O₂ with titanium introduced therein as a cathode active material is greatly reduced. Also, in order to determine the cause of the phenomenon, in-situ X-ray analysis is performed at about 25° C. and about 60° C.

In general, the phase change of the LiNi_{1/3}Co_{1/3}Mn_{1/3}O₂ cathode active material during a charging process is as follows. During a first charging process, as the (003) peak shifts to a low angle, an H1 phase changes to an H2 phase, and as the (003) peak shifts back to a high angle, the H2 phase changes to an H3 phase. That is, two phase changes occur.

A difference between the phase change behavior of LiNi_{1/3}Co_{1/3}Mn_{1/3}O₂ without titanium and the phase change behavior of LiNi_{1/3}Co_{1/3}Mn_{1/3}O₂ with titanium may be confirmed in the second phase change from the H2 phase to the H3 phase, which occurs at a high temperature. As shown in FIGS. 13B and 13E, with respect to the phase change behavior at room temperature, the (003) peak shifts to a low angle at the beginning of charging and shifts to a high angle at the end of charging, and a shoulder peak is generated at a high voltage above about 4.6 volts (V), resulting in local shrinkage of a crystal structure. However, it is difficult to determine a difference between the two active materials because they show similar phase change behavior at room temperature regardless of whether titanium is introduced or not.

On the other hand, according to FIGS. 13C and 13F, as a result of in-situ X-ray analysis at about 60° C., the LiNi_{1/3}Co_{1/3}Mn_{1/3}O₂ cathode active material without titanium shows only a wider shoulder peak without a significant difference compared to the phase change behavior at room temperature, but the LiNi_{1/3}Co_{1/3}Mn_{1/3}O₂ cathode active material with titanium shows a difference in which a narrower and larger peak than the shoulder peak appears during high-temperature and high-voltage operation. Through these results, it may be determined that a large change in the crystal structure, such as the formation of other crystal phases during high-temperature and high-voltage operation in the LiNi_{1/3}Co_{1/3}Mn_{1/3}O₂ with titanium, occurs, and it may be inferred that the large change is the cause of an irreversible decrease in capacity due to the introduction of titanium. The embodiments suggest that, by checking the phase change behavior of a cathode active material through in-situ X-ray analysis results during high-temperature operation, the problem of poor stability of the cathode active material during high-temperature operation may be explained in relation to the high-temperature in-situ X-ray analysis results.

Hereinafter, an in-situ X-ray analysis result of the in-situ electrochemical cell 50 using anatase TiO₂ nanoparticles as an anode active material is described with reference to FIGS. 14A to 19B.

FIG. 14A and FIG. 14B are voltage-capacity graphs of electrochemical cells including anatase TiO₂ anode active material at room temperature RT and about 60° C., respectively, and FIG. 14C and FIG. 14D are cyclic voltammogram (CV) graphs at room temperature RT and about 60° C., respectively.

Referring to FIGS. 14A to 14D, an electrochemical cell is prepared using nanoparticles having a size of about 12 nm, prepared by a sacrificial template method, as anatase TiO₂ anode active material. As a result of room temperature test, the electrochemical cell has a capacity of about 180 mAh/g and a first plateau appears at about 1.75 V due to the insertion reaction of lithium.

TiO₂→Li_{0.55}TiO₂ (2)

At about 60° C., the electrochemical cell exhibits a larger capacity (e.g., about 250 mAh/g), and it may be inferred that the exhibition of the larger capacity is due to extension in a low voltage slope region. It may be inferred that the expansion is due to interfacial pseudo-capacitive charge storage or extra lithium insertion through sequential phase transition from Li_{0.55}TiO₂ to Li₁TiO₂. Also, the region indicated by the dashed rectangle in FIG. 13B clearly shows that a pseudo-plateau appears at approximately 1.5 V. Accordingly, it may be determined that a significant change appears in a lithium insertion mechanism due to the elevated temperature environment at a high temperature as opposed to at room temperature.

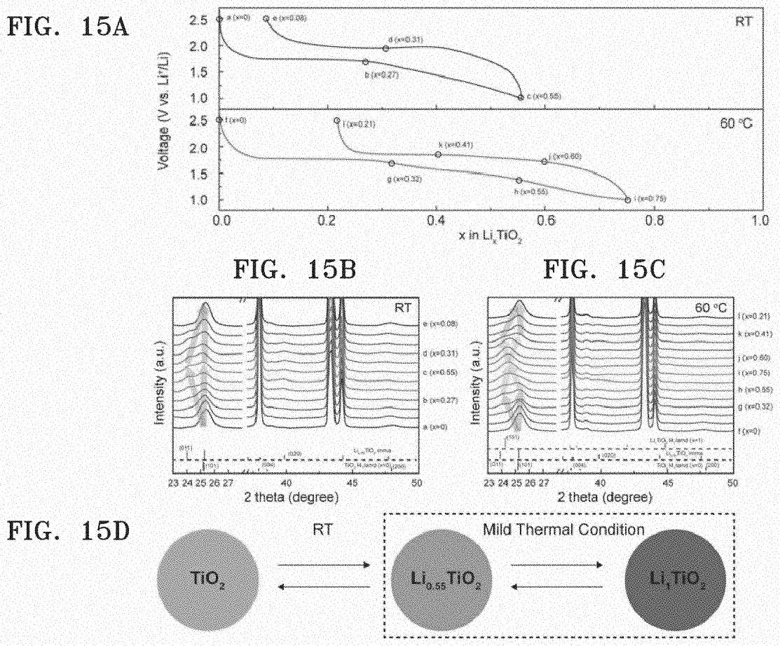

FIG. 15A is a voltage profile during a first cycle at room temperature RT and about 60° C., FIG. 15B and FIG. 15C are in-situ X-ray analysis results during the first cycle at room temperature RT and about 60° C., respectively, and FIG. 15D is a schematic diagram of a lithium intercalation model of anatase TiO₂.

As shown in FIG. 15A, anatase TiO₂ reacts with 0.75 Li at about 60° C. as opposed to reacting with 0.55 Li at room temperature. At room temperature, an orthorhombic crystal structure may be maintained up to 0.55 Li (TiO₂→Li_{0.55}TiO₂), and this phase transition may be confirmed by the reversible occurrence of a (011) peak and the shift of a (101) peak. On the other hand, at about 60° C., an additional phase transition to tetragonal Li₁TiO₂ is observed in a range from 0.55 Li to 0.75 Li. Therefore, at about 60° C., the following sequential phase transitions may occur.

TiO₂→Li_{0.55}TiO₂→Li₁TiO₂ (3)

Also, due to the shift of the (101) peak at about 60° C., an increased lattice constant of about 3.61 Å at the point of 0.75 Li is obtained. This is a feature that is not observed at room temperature and may be observed only at about 60° C., and it may be inferred that the lattice constant extended by the elevated temperature condition has a tendency to induce an additional phase transition.

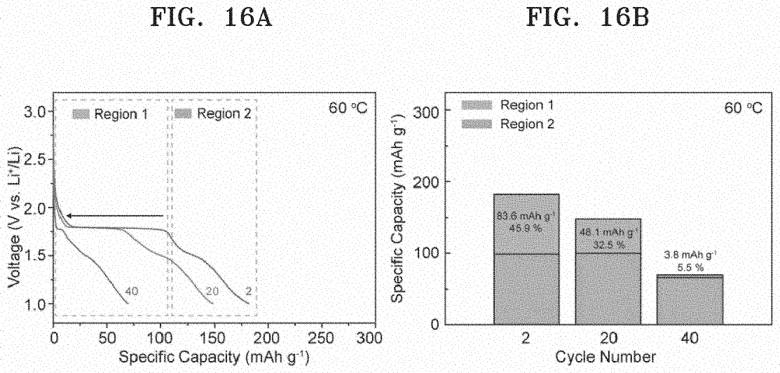

FIG. 16A illustrates a voltage-capacity profile at 2 cycles, 20 cycles, and 40 cycles performed at about 60° C., and FIG. 16B schematically illustrates certain capacity in a first region (represented as “Region 1”) and a second region (represented as “Region 2”).

The first region indicates a voltage interval up to a point where a voltage plateau appears in the voltage-capacity profile, and the second region indicates a voltage interval after the voltage plateau. The first region is a region in which lithium intercalation (TiO₂->Li_{0.55}TiO₂) occurs, and the second region is a region, which includes a low voltage slope region and in which additional phase transition to Li₁TiO₂ occurs. As the number of cycles increases, the proportion of the capacity in the first region to the total capacity sharply decreases from about 45.9% (2 cycles) to about 5.5% (40 cycles). Although not shown, this phenomenon is not observed at all at room temperature, and it may be determined that the tendency of capacity decrease according to an increase in the number of cycles at room temperature is relatively low. It may be inferred that the additional phase transition in the elevated temperature condition sharply degrades battery performance in a subsequent cycle.

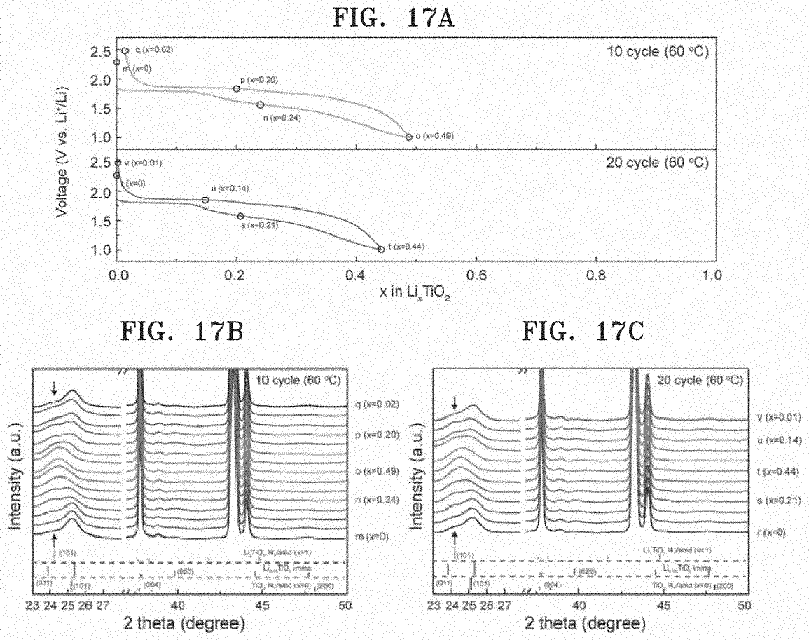

FIG. 17A illustrates a voltage profile at 10 cycles and 20 cycles, and FIG. 17B and FIG. 17C are in-situ X-ray analysis results at 10 cycles and 20 cycles, respectively.

There is a shoulder peak of a (101) peak in 10 cycles, which means that Li_{0.55}TiO₂ as well as anatase TiO₂ coexist with Li₁TiO₂ already before the operation of the electrochemical cell. That is, it indicates that some of the lithium ions are trapped in a crystal lattice and may not be completely deintercalated.

At 20 cycles, a shoulder peak around about 24° is more clearly observed, which suggests that incomplete deintercalation accumulates and slowly blocks a lithium intercalation pathway within the anatase TiO₂. That is, it may be inferred that the irreversible trapping of lithium ions at elevated temperature is related to the degradation of cycle characteristics.

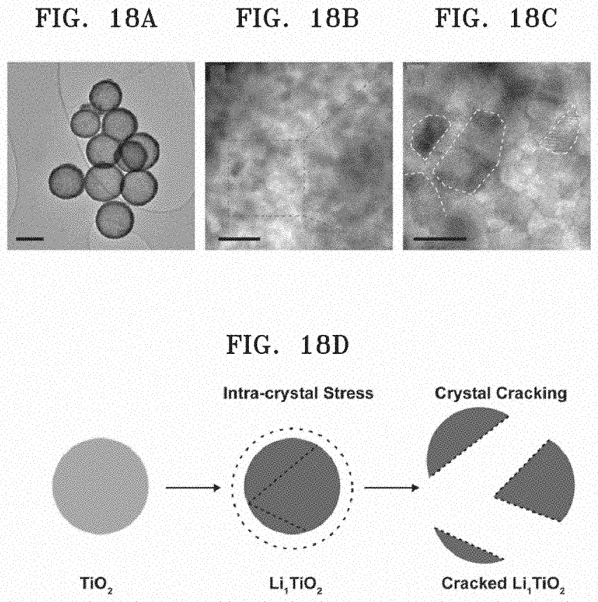

FIGS. 18A, 18B, and 18C are a coefficient of spherical aberration (Cs) corrected scanning transmission electron microscope (Cs-STEM) images of nanoparticles after 20 cycles at about 60° C. FIG. 18D is a schematic diagram showing a degradation mode due to intra-crystal stress generation in an electrochemical cell. Scale bars in FIGS. 18A, 18B, and 18C correspond to about 200 nm, about 20 nm, and about 10 nm, respectively.

As shown in FIG. 18A, the anatase TiO₂ has a uniform size of about 12 nm, and a structure in which hollow nanocrystals are interconnected is well preserved even after a cycle test is performed. This is also consistent with the results of previous studies in which a nanocrystal structure in which nanocrystals are interconnected improves cycle stability. As shown in FIGS. 18B and 18C, fragments of smaller nanocrystals with discontinuous interfaces are present within a nanoparticle crystal in a high-resolution image. It may be inferred that this is because sequential phase transition (TiO₂→Li_{0.55}TiO₂→Li₁TiO₂) limits the size of particles of the anatase TiO₂ to about 7 nm or less, causing significant intra-crystal stress, thereby accelerating the occurrence of cracks in nanocrystal particles.

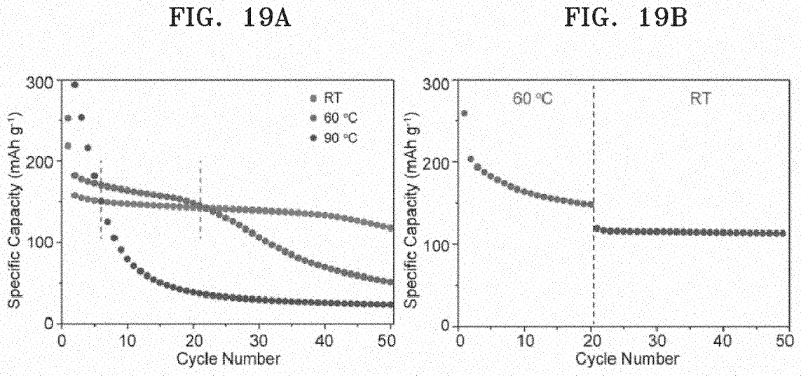

FIG. 19A is a graph showing cycle characteristics at room temperature RT, about 60° C., and about 90° C., and FIG. 19B is a graph showing cycle characteristics of a case in which 20 cycles are performed at about 60° C. and then 30 cycles are performed at room temperature RT. For example, FIG. 19B corresponds an experimental result obtained by sequentially performing a first sub-cycle at a first temperature (about 60° C.) and a second sub-cycle at a second temperature (room temperature) according to the in-situ X-ray analysis method described with reference to FIGS. 7 and 8.

In an initial cycle, discharge capacities of about 218.6 mAh/g, about 252.4 mAh/g, and about 443.6 mAh/g are obtained at room temperature RT, about 60° C., and about 90° C., respectively. That the higher the temperature, the higher the discharge capacity is due to the sequential phase transition described above. However, excessive lithium storage has long-term adverse effects, which may be evidenced by deterioration of cycle characteristics at high temperatures.

According to FIG. 19B, it may be determined whether the cycle performance degradation of anatase TiO₂ caused by a high-temperature cycle is recoverable. First, reduced performance at elevated temperature conditions is irreversible even after heat is removed, and it may be determined that the observation of a sharp decrease in capacity after 20 cycles (after heat is removed) is due to the suppression of the phase transition to Li₁TiO₂ at room temperature. As a result, it may be determined that the sequential phase transition induces significant crystal internal stress and crystal cracks due thereto and the crystal cracks together with accumulated Li₁TiO₂ phase cause significant capacity reduction and irreversible capacity reduction and accelerate battery degradation.

In the above, the present disclosure has been described in detail with reference to preferred embodiments, but the present disclosure is not limited to the above embodiments, and various modifications and changes may be made by those skilled in the art within the inventive concept and scope of the present disclosure.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. An in-situ X-ray analysis apparatus comprising:
a potentiostat connected to an in-situ electrochemical cell and configured to control a voltage, current, and time of the in-situ electrochemical cell, or to record voltage, current, resistance, capacity, and time information of the in-situ electrochemical cell;
an X-ray analysis apparatus configured to obtain X-ray diffraction information of the in-situ electrochemical cell;
a Peltier-type temperature control unit including a base plate on which the in-situ electrochemical cell is mounted, a cap portion covering the in-situ electrochemical cell and having a pair of openings through which X-rays pass through the in-situ electrochemical cell, a temperature controller for heating or cooling the base plate, and a fluid supply line for supplying cooling water to a lower portion of the base plate; and
a controller connected to the potentiostat, the X-ray analysis apparatus, and the Peltier-type temperature control unit and configured to provide or receive a signal to or from each of the potentiostat, the X-ray analysis apparatus, and the Peltier-type temperature control unit.

2. The in-situ X-ray analysis apparatus of claim 1, wherein the temperature controller includes a Peltier-type thermoelectric element,
wherein the Peltier-type temperature control unit is configured to maintain a temperature of the in-situ electrochemical cell in a variable temperature range of about −10° C. to about 80° C.

3. The in-situ X-ray analysis apparatus of claim 1, wherein the in-situ electrochemical cell includes:
a cell case having a plurality of holes through which X-rays irradiated from the X-ray analysis apparatus are transmitted into the in-situ electrochemical cell;
an anode electrode provided in the cell case;
a cathode electrode provided in the cell case;
a separator arranged between the anode electrode and the cathode electrode; and
an electrolyte wetted on at least surfaces of the anode electrode, the cathode electrode, and the separator.

4. The in-situ X-ray analysis apparatus of claim 1, wherein the Peltier-type temperature control unit further includes a cover film attached on the pair of openings of the cap portion and allowing X-rays to pass while the in-situ electrochemical cell is maintained in a sealed environment.

5. The in-situ X-ray analysis apparatus of claim 4, wherein the cover film includes a polymer material that is transparent and does not absorb X-rays.

6. The in-situ X-ray analysis apparatus of claim 1, wherein the potentiostat is further configured to provide information about the capacity, voltage, current, and time of the in-situ electrochemical cell to the controller,
wherein the controller is further configured to, in response to a signal based on the information provided by the potentiostat, provide a command signal for the X-ray analysis apparatus to irradiate X-rays to the in-situ electrochemical cell.

7. The in-situ X-ray analysis apparatus of claim 6, wherein the controller is further configured to derive overpotential information in each state based on the information about the capacity, voltage, current, and time of the in-situ electrochemical cell,
wherein the controller is further configured to determine a delay time during which a command signal is provided to the X-ray analysis apparatus according to the overpotential information.

8. The in-situ X-ray analysis apparatus of claim 7, wherein the delay time is determined to be a time until the overpotential information in each state becomes lower than a threshold overpotential.

9. The in-situ X-ray analysis apparatus of claim 6, wherein the controller is further configured to derive diffusivity information in each state based on the information about the capacity, voltage, current, and time of the in-situ electrochemical cell,
wherein the controller is further configured to determine a delay time during which a command signal is provided to the X-ray analysis apparatus according to the diffusivity information.

10. The in-situ X-ray analysis apparatus of claim 9, wherein the delay time is determined to be a time until the diffusivity information in each state becomes lower than a threshold diffusivity.

11. An in-situ X-ray analysis method comprising:
mounting an in-situ electrochemical cell in a Peltier-type temperature control unit, wherein the Peltier-type temperature control unit is connected to a controller and operates in a variable temperature range of about −10° C. to about 80° C.; and
performing a plurality of in-situ X-ray analysis cycles on the in-situ electrochemical cell,
wherein each of the plurality of in-situ X-ray analysis cycles includes:
obtaining, by a potentiostat connected to the in-situ electrochemical cell, information about capacity, voltage, current, and time of the in-situ electrochemical cell;
providing the information about the capacity, voltage, current, and time of the in-situ electrochemical cell from the potentiostat to the controller;
deriving, by the controller, overpotential information or diffusivity information in each state of the in-situ electrochemical cell, based on the information about the capacity, voltage, current, and time;
determining, by the controller, a delay time based on the overpotential information or the diffusivity information;
providing a command signal from the controller to an X-ray analysis apparatus, connected to the controller, after the delay time has elapsed; and
irradiating, by the X-ray analysis apparatus, X-rays to the in-situ electrochemical cell to obtain an X-ray diffraction pattern.

12. The in-situ X-ray analysis method of claim 11, wherein the Peltier-type temperature control unit includes:
a base plate on which the in-situ electrochemical cell is mounted;
a cap portion covering the in-situ electrochemical cell and having a pair of openings through which X-rays pass through the in-situ electrochemical cell;
a temperature controller for heating or cooling the base plate; and
a fluid supply line for supplying cooling water to a lower portion of the base plate.

13. The in-situ X-ray analysis method of claim 11, wherein the performing of the plurality of in-situ X-ray analysis cycles on the in-situ electrochemical cell includes:
performing an in-situ X-ray analysis cycle during a charging process for the in-situ electrochemical cell at a first temperature; and
performing an in-situ X-ray analysis cycle during a discharging process for the in-situ electrochemical cell at a second temperature different from the first temperature.

14. The in-situ X-ray analysis method of claim 13, wherein the first temperature and the second temperature are determined considering a use environment of the in-situ electrochemical cell.

15. The in-situ X-ray analysis method of claim 13, wherein at least one of the first temperature and the second temperature is in a range of about −10° C. to about 10° C.

16. The in-situ X-ray analysis method of claim 11, wherein the performing of the plurality of in-situ X-ray analysis cycles on the in-situ electrochemical cell includes:
performing a plurality of first sub-cycles, wherein the plurality of first sub-cycles include performing an in-situ X-ray analysis cycle in a charging and discharging process for the in-situ electrochemical cell at a first temperature; and
performing a plurality of second sub-cycles, wherein the plurality of second sub-cycles include performing an in-situ X-ray analysis cycle in a charging and discharging process for the in-situ electrochemical cell at a second temperature different from the first temperature.

17. The in-situ X-ray analysis method of claim 11, wherein the delay time is determined to be a time until the overpotential information or the diffusivity information in each state of the in-situ electrochemical cell becomes lower than a threshold overpotential or a threshold diffusivity.

18. The in-situ X-ray analysis method of claim 11, wherein the delay time is determined to be a constant value regardless of the overpotential information or the diffusivity information.
